(19) United States
(12) Patent Application Publication
(10) Pub. No.: US 2025/0091387 A1
(43) Pub. Date: Mar. 20, 2025

(54) NON-PNEUMATIC TIRE

(71) Applicant: The Goodyear Tire & Rubber Company, Akron, OH (US)

(72) Inventors: Junling Zhao, Hudson, OH (US); Francesco Sportelli, Bettembourg (LU); Joseph Carmine Lettieri, Hudson, OH (US)

(21) Appl. No.: 18/469,000

(22) Filed: Sep. 18, 2023

(51) Int. Cl. B60C 7/10; B32B 3/30; B32B 5/26; B32B 37/12; B32B 38/00; B60C 7/22; B60C 9/18

(52) U.S. Cl. CPC B60C 7/102; B32B 3/30; B32B 5/26; B32B 37/1292; B32B 38/00; B60C 7/22; B60C 9/1807; B32B 2038/0076; B32B 2398/20

(57) ABSTRACT

The invention is directed to a non-pneumatic tire comprising a circumferential tread portion, a circumferential shearband carrying the tread portion, a hub portion, and a supporting structure supporting the shearband on the hub portion. Said shearband and supporting structure are mechanically interlocked with each other and/or the tire comprises a fabric layer extending along a radially inner surface of the shearband and a radially outer surface of the supporting structure. The invention is also directed to a method of making a non-pneumatic tire, comprising the steps of providing a fabric layer having a first surface with a plurality of protrusions, applying a thermoplastic polymer onto the first surface to form a portion of a supporting structure, providing a shearband, and curing the shearband to a second surface of the fabric layer, which is opposite to the first surface.

### FIELD OF THE INVENTION

The present invention is directed to a non-pneumatic tire comprising a tread, a shearband carrying the tread, and a supporting structure supporting the shearband.

### BACKGROUND OF THE INVENTION

One advantage of non-pneumatic tires consists in that they do not require pressured air within a tire cavity and are thus puncture resistant. Various non-pneumatic tire constructions have been suggested in the prior art. While considerable progress has been made in the development of such non-pneumatic tires over the past years, significant room for improvement remains.

### SUMMARY OF THE INVENTION

In a first aspect of the present invention, the invention is directed to a non-pneumatic tire comprising a circumferential tread portion, a circumferential shearband carrying the tread portion, a hub portion, and a supporting structure supporting the shearband on the hub portion. Still in accordance with the first aspect of the invention, the shearband and the supporting structure are mechanically interlocked with each other.

In a second aspect of the present invention, the invention is directed to a non-pneumatic tire comprising a circumferential tread portion, a circumferential shearband carrying the tread portion, a hub portion, and a supporting structure supporting the shearband on the hub portion. Furthermore, the tire comprises a fabric layer extending along a radially inner surface of the shearband and a radially outer surface of the supporting structure.

In a third aspect of the present invention, the invention is directed to a method of making a non-pneumatic tire, the tire comprising a tread portion, a shearband carrying the tread portion, and a supporting structure supporting the shearband. The method comprises the step of providing a fabric layer comprising a first surface and a second surface opposite to the first surface, wherein said first surface of the fabric layer comprises a plurality of protrusions. Furthermore, the method comprises the step of applying a thermoplastic polymer onto the first surface to form a portion of the supporting structure comprising the plurality of protrusions protruding into the thermoplastic polymer. In another step, a shearband is provided and cured to the second surface of the fabric layer.

### BRIEF DESCRIPTION OF THE DRAWINGS

The invention will be described by way of example and with reference to the accompanying drawings in which:

FIG. 1 is a schematic sideview of a non-pneumatic tire in accordance with an embodiment of the present invention;

FIG. 2 is a partial schematic cross-section through the tread portion, the shearband and a radially outer portion of the supporting structure of the tire shown in FIG. 1;

FIG. 3 is a partial schematic cross-section through a tread portion, a portion of a shearband and a radially outer portion of a supporting structure of a non-pneumatic tire having a toothed shearband, in accordance with another embodiment of the present invention;

FIG. 4 is a partial schematic cross-section through a tread portion, a portion of a shearband and a radially outer portion of a supporting structure of another non-pneumatic tire, in which the shearband is connected to the supporting structure via an adhesive coated fabric layer with hooks and a transition layer, also in accordance with another embodiment of the present invention;

FIG. 5 is a partial schematic cross-section through a tread portion, a shearband, and a radially outer portion of a supporting structure, partially encompassing the shearband, of another non-pneumatic tire in accordance with still another embodiment of the present invention;

FIG. 6 is a partial schematic cross-section through a tread portion, a shearband, and a radially outer portion of a supporting structure of another non-pneumatic tire in accordance with still another embodiment of the present invention, in which the shearband partially encompasses the supporting structure;

FIG. 7 is a partial schematic cross-section through a tread portion, a shearband, and a radially outer portion of a supporting structure of still another non-pneumatic tire in accordance with still another embodiment of the present invention, in which the shearband partially encompasses the supporting structure;

FIG. 8 is a partial schematic cross-section through a tread portion, a shearband, and a radially outer portion of a supporting structure partially encompassing the shearband, with a textured fabric layer arranged at an interface of the shearband and the supporting structure, all in accordance with still another embodiment of a tire of the present invention;

FIG. 9 is a partial schematic cross-section through a tread portion, a shearband, and a radially outer portion of a supporting structure of another non-pneumatic tire in accordance with still another embodiment of the present invention, in which the shearband partially encompasses the supporting structure and a textured fabric layer is arranged at the interface between the shearband and the supporting structure;

FIG. 10 is a partial schematic cross-section through a tread portion, a shearband, and a radially outer portion of a supporting structure of still another non-pneumatic tire in accordance with still another embodiment of the present invention, in which the shearband partially encompasses the supporting structure and a textured fabric layer is arranged at the interface between the shearband and the supporting structure;

FIG. 11 is a schematic chart showing experimentally determined peel strengths of different samples of shearbands attached to portions of a supporting structures;

FIG. 12 schematically shows a method of connecting a tread portion and a shearband to a supporting structure of a non-pneumatic tire, in accordance with an embodiment of the present invention; and

FIG. 13 schematically shows a method of connecting a tread portion and a shearband to a supporting structure of a non-pneumatic tire, in accordance with another embodiment of the present invention.

### DETAILED DESCRIPTION OF THE INVENTION

According to the first aspect of the present invention, the invention is directed to a non-pneumatic tire comprising a circumferential tread portion, a circumferential shearband carrying the tread portion, a (circumferential) hub portion, and a supporting structure supporting the shearband on the hub portion. In particular, the shearband and the supporting structure are mechanically interlocked with each other. Such mechanical interlocking improves the bond between supporting structure and shearband.

In one embodiment, a radially outer surface (or side) of the supporting structure and a radially inner surface (or side) of the shearband are mechanically interlocked with each other.

In another embodiment, the tire comprises a fabric layer arranged (at least partially) along and/or between a radially outer surface (or side) of the supporting structure and a radially inner surface (or side) of the shearband. Such a fabric layer helps to bond the supporting structure to the shearband. In particular, the fabric layer may help to improve the bond between the rather rigid supporting structure and the softer and/or more flexible surface of the shearband, typically comprising a rubber composition.

In still another embodiment, the fabric layer comprises or is one or more of a fabric and a textured fabric. For instance, said texture comprises one or more of loop, hook, mushroom hook, woven, knit, fuzzy, and fur structures.

In still another embodiment, the fabric layer is one or more of: extending essentially in the circumferential direction; flat; and a band. It is also possible that the fabric layer extends along a toothed surface of one or more of the shearband, the supporting structure, and a connecting layer.

In still another embodiment, the fabric or textured fabric comprises a plurality of cords and/or fibers extending out of a surface of the fabric or textured fabric. Preferably, a majority of such cords and/or fibers extend out of a (radially inner) side or surface of the fabric facing the supporting structure. For instance, such a side or surface can be mentioned herein as a first side or first surface. Optionally, only one side or surface of the fabric layer comprises the cords and/or fibers extending out of the surface or side of the fabric layer, whereas an opposite (or second) side or surface of the fabric layer does not necessarily comprise such cords and/or fibers extending out of that opposite side or opposite surface. In other words, optionally, the fabric layer is only textured on one side or surface. However, as another option, it is also possible that the fabric layer is textured on both (opposite) sides or surfaces, and/or has cords and/or fibers extending out of both of its sides or surfaces of the fabric.

In still another embodiment, the fabric layer comprises an adhesive coating. Preferably, the adhesive coating is selected from one or more of isocyanate adhesives, latex adhesives, solvent based adhesives, reactive adhesives, resorcinol formaldehyde latex adhesives, epoxy adhesives, phenol form aldehyde adhesives, polyurethane adhesives, nylon-phenolic adhesives, nitrile-phenolic adhesives, nitrile-based adhesives, neoprene adhesives, modified epoxy adhesives, cyanoacrylate adhesives, modified phenolic adhesives, and resorcinol-formaldehyde adhesives. In particular, such an adhesive further improves the bond in addition to mechanical interlocking. Optionally, said adhesive is provided on both sides of the fabric layer. If provided on a side of the fabric layer facing the shearband, it can improve adhesion to the shearband, such as co-cure to the shearband.

In still another embodiment, the cords and/or fibers have one or more of: one or more of loop shapes, hook shapes, mushroom hook shapes, rod shapes, angled shapes, zigzag shapes, corrugated shapes, and curved shapes (wherein hooks are preferred). In addition, or alternatively, they have a diameter within a range of 0.01 mm and 3 mm, preferably 0.02 mm to 1 mm; and/or a maximum radial extension or height within a range of 0.5 mm and 20 mm, preferably 0.7 mm to 10 mm, 1 mm to 10 mm, and even more preferably 1 mm to 5 mm. Optionally, it is also possible, that the cords and/or fibers are arranged in three-dimensional patterns, such as grids, scales, blades, or combinations of such shapes. For instance, hooks optionally have a diameter within a range of 0.1 mm and 0.8 mm and/or a radial height within a range of 0.7 mm and 7 mm. Stems of mushroom hooks may be within the same range. A head portion of a mushroom hook preferably has a maximum diameter of 0.5 mm to 3 mm, or even more preferably of 0.7 mm to 2 mm, and a height of 0.2 mm to 1.5 mm, preferably 0.3 mm to 1 mm. Loops preferably have a diameter of 0.01 mm to 0.3 mm or 0.02 mm to 0.1 mm. It is also possible that multiple loops (such as 5 to 20 loops) form bundles of loops. As another option, the number of cords and/or fibers extending out of a surface of the fabric or textured fabric per 100 mm² is within a range of 10 to 1000, preferably 20 to 500. In other words, such an area may, e.g., comprise from 10 to 1000, preferably from 20 to 500 hooks and/or loops. Loops may, e.g., form multiple bundles of loops.

In still another embodiment, at least one of a radially outer surface or side of the supporting structure and a radially inner surface or side of the shearband comprises protrusions. For instance, such protrusions may have a radial height within a range of 1 mm to 30 mm, preferably from 2 mm to 20 mm, or even more preferably 3 mm to 15 mm. In an embodiment, the term protrusions comprises also cords and/or fibers.

In still another embodiment, lateral distances between the protrusions may optionally be within the range of 1 mm to 30 mm, preferably 2 mm to 20 mm, or even more preferably 3 mm to 15 mm. The maximum width of such protrusions may be within the range of 1 mm to 30 mm, preferably 2 mm to 20 mm, or even more preferably 3 mm to 15 mm. Optionally, the protrusions have an elongated shape. In addition, or alternatively, the elongated protrusions extend essentially in parallel to the circumferential direction of the tire. This helps to withstand forces in the axial direction. In addition, or alternatively, elongated protrusions extend transversely to a circumferential direction of the tire. This mainly helps to withstand forces acting in the circumferential direction. As an option, elongated protrusions have one or more of a length of at least 5 cm, and a maximum width within a range of 1 mm to 30 mm, preferably 2 mm to 30 mm. Optionally, cross-sections of the protrusions include rectangular cross-sections, triangular cross-sections, dovetail shaped cross-sections, trapezoidal shaped cross-sections, T-shaped cross-sections, and mushroom shaped cross-sections.

In still another embodiment, the supporting structure comprises a polymer which engages into protrusions of the shearband. As an option, the polymer is applied, preferably injection molded or rotational molded, onto the shearband. Preferably, the polymer is liquid during application, such as during injection molding or rotational molding. For instance, said protrusions may be an integral part of the shearband or elements of a connecting layer (such as a toothed belt) connected to the shearband. For instance, the polymer may be one or more of: i) one or more polyamide polymers (such as PA12, PA11, PA6); ii) one or more thermoplastic polymers such as thermoplastic polyester elastomers, thermoplastic polyurethane elastomers, polyamide thermoplastic elastomers, elastomer alloy thermoplastic vulcanizates, thermoplastic polyolefin elastomers, styrenic thermoplastic elastomers, thermoplastic resins (such as polyester resins, polyamide resins, or polyurethane resins). In particular, the term thermoplastic polymer shall include herein also thermoplastic resins.

In a preferred option, the polymer is a thermoplastic polymer, such as a thermoplastic polyester elastomer.

In still another embodiment, one of the supporting structure and the shearband at least partially encompasses the other one of the supporting structure and the shearband (preferably, in a radial direction) to avoid axial movement of the supporting structure relative to the shearband. In addition, or alternatively, one of the supporting structure and the shearband comprises a radial projection on each of its axially inner side and axially outer side to secure and/or support the other one of the supporting structure and the shearband against relative axial movement between the supporting structure and the shearband. Optionally, said radial projection comprises an extension into an inner axial direction. Such a design further helps to avoid a radial relative movement or separation of the supporting structure and shearband.

In still another embodiment, a connecting layer is provided between the supporting structure and the shearband, wherein the connecting layer optionally comprises one or more of a circumferential fabric (layer) comprising a plurality of cords and/or fibers extending out of the surface of the fabric (layer); and a, preferably circumferential, toothed belt. Optionally, said toothed belt has teeth on each of its radially inner surface or side and radially outer surface or side. In other words, toothed may also be understood herein as ribbed or corrugated. Thus, the belt may have ribs. Optionally, a fabric layer comprising a fabric with a plurality of cords and/or fibers extending out of the surface of the fabric is provided at least on the radially inner side of the toothed belt. This helps to further improve the bond and interlocking between the supporting structure and the belt. The toothed belt comprises preferably a rubber composition. The belt can be co-cured to the shearband. Optionally, the toothed belt has a toothed radially inner surface and an essentially flat radially outer surface, optionally co-cured or co-curable to the shearband. Optionally, one or more of the surfaces of the belt may be coated with an adhesive mentioned herein. In addition, or alternatively, the radially outer surface of the belt may be coated with a primer as further described herein below.

According to the second aspect, a non-pneumatic tire comprises a circumferential tread portion, a circumferential shearband carrying the tread portion, a hub portion, and a supporting structure supporting the shearband on the hub portion. Still in accordance with the second aspect, the tire further comprises a fabric layer extending (preferably circumferentially) along a radially inner surface (or side) of the shearband and a radially outer surface (or side) of the supporting structure. The fabric layer helps to improve the bond between the rigid supporting structure and the surface of the shearband.

In one embodiment, the fabric layer comprises a fabric with one or more of cords and fibers extending out of a surface or side of the fabric, optionally as described in one or more embodiments of the first aspect herein above.

In another embodiment, the fabric layer comprises a material selected from one or more of polyester (preferably, PET), polyamide (preferably, one or more of PA 6, PA 6.6, e.g., Nylon™, aromatic polyamide, e.g., aramid). Optionally, one or more of these materials may be recycled materials. Using hybrid materials or cords of multiple such materials is also an option. Further suitable materials may also comprise rayon, glass, carbon, plant based, and metal (such as steel) material. In particular, the fabric layer, including the fabric and cords and/or fibers extending out of a surface or side of the fabric may comprise one or more of said materials.

In still another embodiment, the fabric layer is coated with an adhesive, preferably at least (or only) on a surface or side having one or more of the cords and fibers extending out of the surface or side of the fabric. In particular, the combination of an adhesive with the fabric layer improves the durability of the interface between the shearband and the relatively rigid supporting structure. Optionally, the surface or side facing the shearband is also coated with an adhesive.

In still another embodiment, the adhesive is chosen as already mentioned herein above.

In still another embodiment, the fabric layer is brushed and/or dip coated such as with a resorcinol formaldehyde latex (RFL) based dip, preferably on said second surface for bonding the fabric layer to the shearband. Such a dip coating material improves co-curability of the fabric layer with the shearband.

In still another embodiment, the supporting structure comprises a thermoplastic polymer (optionally a thermoplastic elastomer, such as a thermoplastic polyester elastomer, which is the most preferred material herein).

In still another embodiment, the supporting structure comprises a thermoplastic polymer (optionally a thermoplastic elastomer, such as a thermoplastic polyester elastomer) and the fabric layer comprises a plurality of one or more of cords and fibers extending out of a surface of the fabric into the thermoplastic polymer of the supporting structure. Optionally, the fabric layer is co-cured to the shearband. In other words, a first side or surface of the fabric layer is connected to the thermoplastic polymer of the supporting structure, and a second, opposite side or surface of the fabric layer is connected to the shearband. Thus, the first side or surface faces the supporting structure and the second side or surface faces the shearband. Preferably, the first side of the fabric layer is coated with an adhesive as mentioned herein above. Optionally, both sides of the fabric layer are coated (such as brushed) with the adhesive.

In still another embodiment, the thermoplastic polymer of the supporting structure is (preferably, injection-) molded onto the fabric layer, optionally so that the one or more of cords and fibers extend into the thermoplastic polymer and/or are enclosed by the thermoplastic polymer.

In still another embodiment, the tire further comprises a rubber composition-based transition layer, wherein the fabric layer is cured to the shearband via the transition layer. Thus, (a radially inner surface or side of) the shearband is connected to the transition layer, the transition layer is connected to the fabric layer (which is optionally coated with adhesive as mentioned above, or particularly dip coated, e.g., with an RFL based coating or dip), and the fabric layer is connected to the thermoplastic material of the supporting structure, optionally including also said adhesive. The transition layer may preferably be provided in case of a connection of an already cured shearband to the fabric layer but can also be applied when connecting an uncured shearband to the fabric layer. It is typically preferred that the shearband is still uncured when applying the fabric layer onto the shearband.

In still another embodiment, the shearband and/or the transition layer may be treated with a primer, such as a halogen oxidizing agent. Examples of such agents include sodium hypochlorite, and trichlorisocyanuric acid (such as Chemlok™ 7701).

In still another embodiment, said cords and/or fibers extending out of the fabric are one or more of hook-shaped and loop-shaped and/or are coated with one or more of a solvent-based adhesive, an isocyanate adhesive (or, in other words, an adhesive comprising isocyanates), and a solvent-based adhesive comprising isocyanates, such as comprising polyisocyanate and/or diisocyanates. Optionally, the adhesive may additionally comprise one or more rubber latexes. In addition, or alternatively, the thermoplastic polymer is a thermoplastic elastomer, such as a thermoplastic polyester elastomer. In addition, or alternatively, the fabric comprises a material chosen from polyester and polyamide, preferably one or more of PET, PA 6, and PA 6.6, even more preferably PA 6.6/Nylon™. In addition, or alternatively, the shearband comprises an elastomer composition (preferably rubber composition) comprising one or more of natural rubber, synthetic polyisoprene, styrene butadiene rubber and polybutadiene rubber. It is optionally reinforced by textile and/or metal cords.

According to the third aspect of the present invention, the invention is directed to a method of making a non-pneumatic tire. The tire comprises a tread or tread portion, a shearband carrying the tread portion, optionally a hub portion, and a supporting structure supporting the shearband, optionally on the hub portion. The method comprises the step of providing a fabric layer comprising two opposite surfaces, comprising a first surface and a second surface opposite to the first surface, wherein said first surface of the fabric layer comprises a plurality of protrusions. Furthermore, the method comprises the steps of applying a thermoplastic polymer (preferably in a liquid state, such as by injection molding, or by rotational molding) onto the first surface to form a portion of the supporting structure comprising the plurality of protrusions protruding into the thermoplastic polymer; providing a shearband; and curing (or, in other words, co-curing) the shearband to the second surface of the fabric layer. Such a method improves the bond between the shearband and a supporting structure of a non-pneumatic tire. The above steps may be carried out in different orders as further indicated herein below.

In one embodiment, the thermoplastic polymer is injected (such as injection molded) in one step onto the fabric layer (which is optionally coated with an adhesive before injecting the thermoplastic polymer). In a further step, a shearband, such as an uncured shearband, is connected to the fabric layer, e.g., by co-curing the shearband to the fabric layer. Optionally, the thermoplastic polymer is injected with a temperature within the range of 150° C. to 300° C.

In another embodiment, the fabric layer is co-cured in one step to the shearband to connect the shearband to the fabric layer and, in a further step, the thermoplastic polymer is injected onto the fabric layer, to connect the thermoplastic polymer of the supporting structure to the fabric layer (and thus to the shearband).

In another embodiment, a rubber composition-based transition layer is provided (e.g., as described herein above) between the shearband and the fabric layer. Such a step is preferably used if the provided shearband is already a cured shearband to be connected to the fabric layer. However, preferably, an uncured shearband is connected to the fabric layer.

In another embodiment, the method comprises the step of coating at least the first surface of the fabric layer with an adhesive (e.g., an adhesive as mentioned herein above) before injecting the thermoplastic polymer onto the first surface. For instance, brushing may be used. Such a feature provides a combined mechanical and chemical bonding between the supporting structure and the fabric layer. It is possible that the second surface is also coated with an adhesive. In the case of a supporting structure comprising a thermoplastic polyester elastomer, a fabric layer comprising polyester and/or polyamide, and a shearband comprising a rubber composition, a preferred option is to coat both surfaces of the fabric layer with an adhesive comprising isocyanates, particularly with a solvent-based adhesive comprising isocyanates (such as mentioned herein above) as it provides good adhesion to the supporting structure, the fabric material and the rubber composition.

In another embodiment, said fabric layer comprises a fabric and the plurality of protrusions comprise one or more of cords and fibers extending out of the surface of the fabric. Preferably said cords and fibers have one or more of hook and loop shapes (preferably hook shapes).

In still another embodiment, the method is used to make a non-pneumatic tire according to one of the first and second aspects, or one or more of their embodiments.

In still another embodiment, the fabric layer and the shearband facing the fabric layer are co-cured together. Optionally, a rubber composition-based transition layer is provided between the shearband and the fabric layer. As another option, the thermoplastic polymer applied (e.g., injection molded) onto the fabric layer, the transition layer, and the shearband facing the fabric layer are cured.

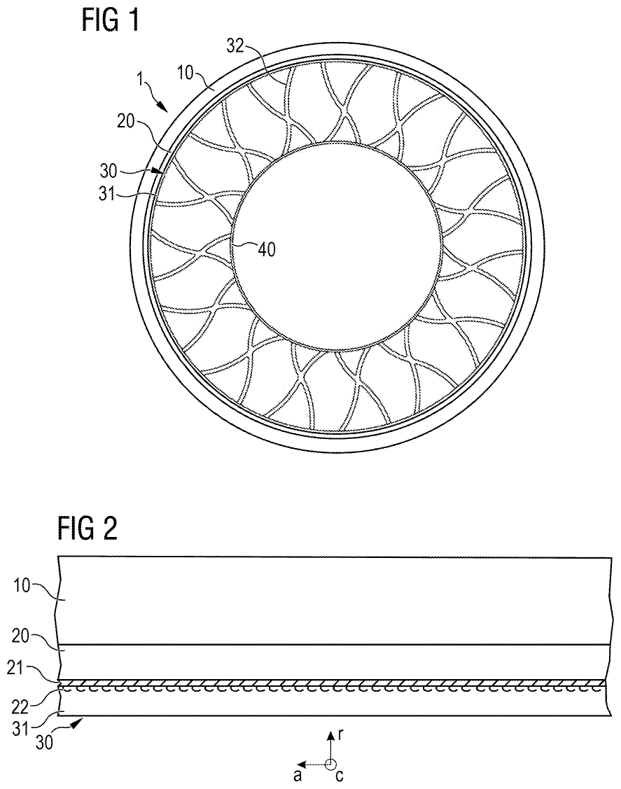

FIG. 1 shows a schematic sideview of a non-pneumatic tire 1, which comprises a circumferential tread portion 10 which is supported by a circumferential shearband 20. Furthermore, the tire 1 comprises a circumferential hub portion 40, wherein the shearband 20 is supported on the hub portion 40 by a supporting structure 30. In the present non-limiting embodiment, the supporting structure 30 comprises a radially outer circumferential ring portion 31 and a plurality of supporting elements, such as spokes 32. Said ring portion 31 is circumferentially adjacent the shearband 20. The tread portion 10 and the shearband 20, typically comprise elastomer compositions, or layers of such compositions, preferably rubber compositions. The supporting structure 30 comprising the ring portion 31 and the plurality of supporting elements or spokes 32, preferably comprises thermoplastic polymers, particularly thermoplastic elastomers. The same may apply to the hub portion 40. The circumferential hub portion 40 is preferably mountable to a rim (not shown) or could be mounted to a wheel hub of a vehicle (not shown). One aim of the present invention is to improve the connection between the shearband 20 and the supporting structure 30, such as with a ring portion 31 of the supporting structure 30. One inventive example of such an improved interface is shown in further detail in FIG. 2.

In particular, FIG. 2 depicts a schematic cross section in a plane perpendicular to the circumferential direction c of the tire. The radially outermost tread portion 10 is carried by the shearband 20. The shearband 20 may comprise multiple stacked reinforced and/or non-reinforced circumferential rubber composition layers which are not separately depicted herein. The ring portion 31 of the supporting structure 30 is arranged radially inside of the shearband 20. In accordance with the present embodiment of the invention, and in order to improve the bond between the supporting structure 30 and the shearband 20, the tire comprises a fabric layer 21 which is arranged along a radially inner side of the shearband 20 and a radially outer side of the supporting structure 30. The fabric layer 21 comprises a fabric with a plurality of protrusions 22, in the present example hooks 22, which extend into the ring portion 31 of the supporting structure 30. The provision of the fabric layer 21 comprising hooks 22 extending from a surface of the fabric provides a mechanical interlocking between the surface of the fabric layer 21 and the supporting structure 30. It is possible that the fabric layer 21 is co-cured to the shearband 20. Optionally, the fabric layer 21 is coated with an RFL dip to support curing the fabric layer 21 to the shearband 20. In the present embodiment, the fabric layer 21 comprises a polyamide 6.6, the protruding hooks 22 have a radial height within a range of 1 mm and 10 mm, and a diameter of 0.1 mm to 1 mm. The hooks 22 extend into the material of the supporting structure 30. For instance, it is possible to injection-mold the material, such as a thermoplastic polymer of the supporting structure 30 onto the fabric layer 21 including the hooks 22. Thus, the supporting structure 30 is mechanically interlocked with the fabric layer 21 which is connected, preferably co-cured to the shearband 20.

The axial direction a, the radial direction r and the circumferential direction c are indicated in FIG. 2 for the sake of better comprehensibility. A reference to one of these directions in the present embodiment, or further embodiments mentioned herein, does not necessarily constitute a limitation to a specific orientation in one of these directions unless indicated otherwise herein.

FIG. 3 shows a partial cross section of another tire portion comprising a tread 10′ carried by a shearband 20′, which is supported by a supporting structure 30′, particularly by a ring portion 31′ of the supporting structure 30′. In the present embodiment, the shearband 20′ comprises a plurality of elongated protrusions 22′, particularly in the form of multiple teeth or ribs. In the present example, the teeth or ribs 22′ extend in the circumferential direction c and primarily help to improve the bond between shearband 20′ and supporting structure 30′ against forces in the axial direction a. However, as the interface between shearband 20′ and supporting structure 30′ is increased in such an embodiment, the bond is also improved against forces acting in the circumferential direction c, or in other directions. A radial height of the protrusions, i.e., the ribs and/or teeth 22′, is preferably within a range of 1 mm to 30 mm, preferably from 2 mm to 20 mm. A (minimum) distance between these protrusions is preferably also within the same range. The same applies to the (maximum) width of the protrusions, both measured in the present example in the axial direction a.

Preferably, the supporting structure 30′, or a portion thereof, is injection molded onto the shearband 20′ entering the space between the protrusions 22′ of the shearband 20′ so as to obtain an interlocked connection of the shearband 20′ and the supporting structure 30′, as shown in FIG. 3. Rotational molding is another non-limiting potential option. However, it is also possible to manufacture and/or pre-mold the shearband 20′ and the supporting structure 30′ with complementary shapes and to co-cure those and/or connect them via an adhesive. In another option, the supporting structure 30′ can be manufactured with a plurality of teeth by a mold. In addition, or alternatively, the shearband (e.g., green shearband) could be pushed into such a toothed surface of the supporting structure (and optionally, co-cured later). As another option, it is possible that the shearband 20′, or layers thereof are reinforced by cords and/or one or more fabrics, particularly along its surface. In another embodiment, a fabric layer is provided between the toothed shearband 20′ and the adjacent complementary shaped supporting structure 31′ (not shown in FIG. 3). In particular, such a fabric layer could extend in an undulating shape along the interface between the shearband and the adjacent supporting structure. The fabric layer may be textured as mentioned herein above, such as with hooks or loops extending into a thermoplastic polymer material of the supporting structure. Moreover, it may be co-cured to the shearband and/or covered on one or both of its sides with an adhesive.

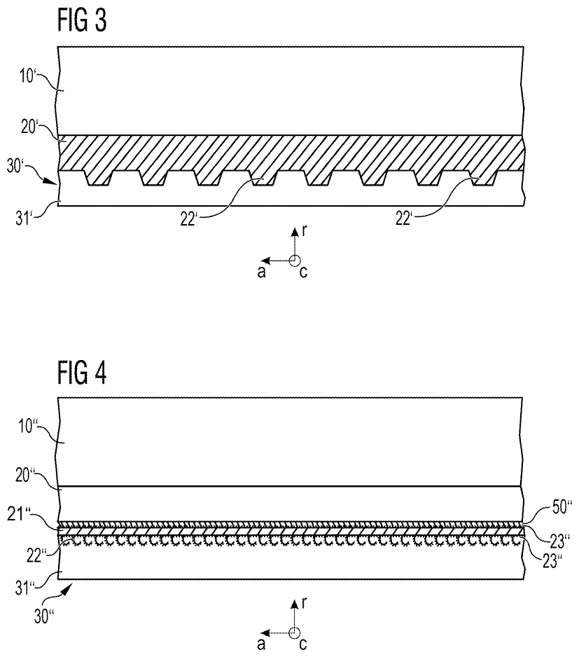

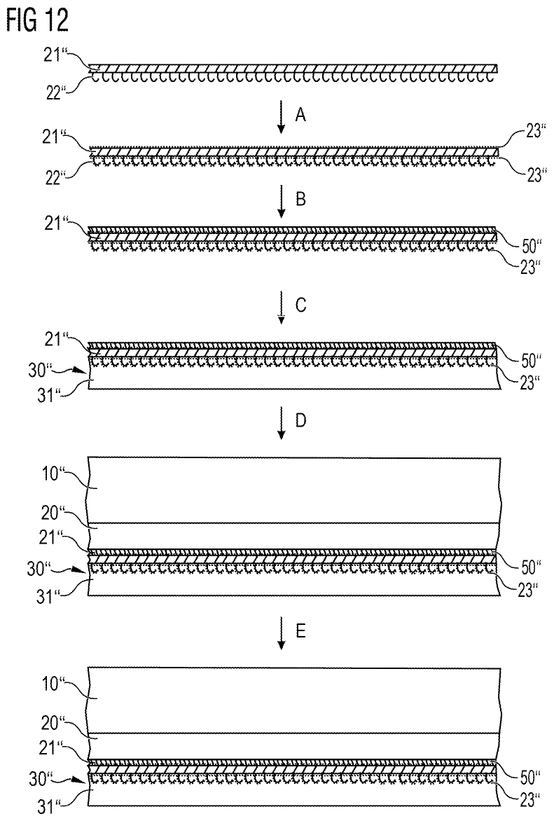

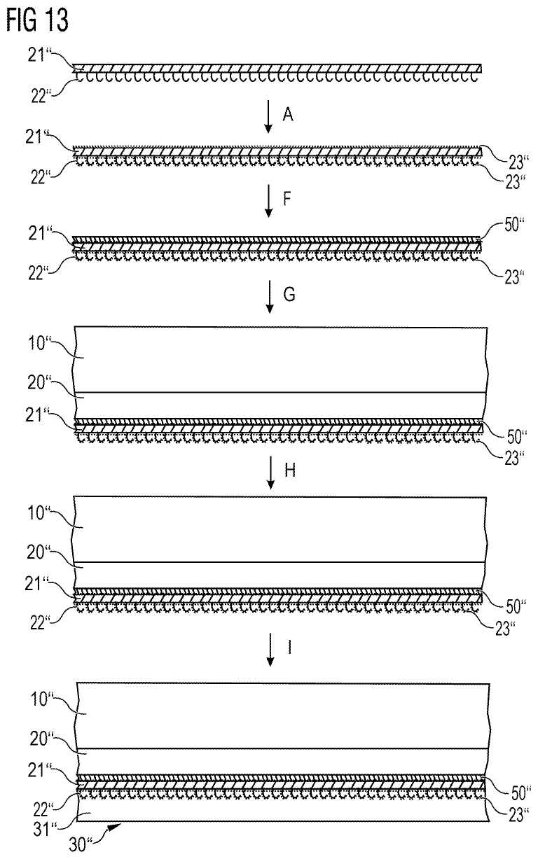

In the embodiment of FIG. 4, the tread 10″ is supported by the shearband 20″. The supporting structure 30″ is injection molded in its ring portion 31″ onto the fabric layer 21″, wherein the protrusions 22″ (here hook-shaped fibers) of the fabric layer 21″are embedded in the supporting structure's thermoplastic polymer. Before injection molding the supporting structure 30″ onto the fabric layer 21″ an adhesive 23″ has been applied to both surfaces of the fabric layer 21″, for example by brushing. Thus, the adhesive 23″ covers also the hook-shaped fibers 22″. In the present example, the shearband 20″ and the tread 10″ are assumed to be uncured before assembly with the supporting structure 30″ bonded to the fabric layer 21″. In order to further improve the bond between the fabric layer 21″ connected to the supporting structure 30″ to the cured shearband 20″, a (circumferential) transition layer 50″ has been provided between the fabric layer 21″ and the shearband 20″. Such a transition layer 50″ comprises preferably an uncured rubber composition such as comprising natural rubber and/or synthetic polyisoprene, which is then co-cured to the fabric layer 21″ and the shearband 20″ (optionally with the tread 10″ and the supporting structure 30″). However, such a transition layer 50″ can also be omitted, particularly, in case of assembling an uncured shearband to the fabric layer. Further details about methods of connecting shearband 20″ and supporting structures 30″ are discussed in FIGS. 12 and 13 in further detail.

FIG. 5 shows another partial cross-section of a tread portion 101, a shearband 201 and a portion of a supporting structure 301, such as a radially outer annular member 311. In this embodiment of the invention, the supporting structure 301 comprises projections 321 extending essentially in a radially outer direction, and overlapping with the shearband 201 so as to avoid a relative movement of the shearband 201 in an axial direction. These projections 321 are provided at axially outermost portions of the supporting structure 301. Such a mechanical interlocking helps to improve the bond between the shearband 201 and the supporting structure 301.

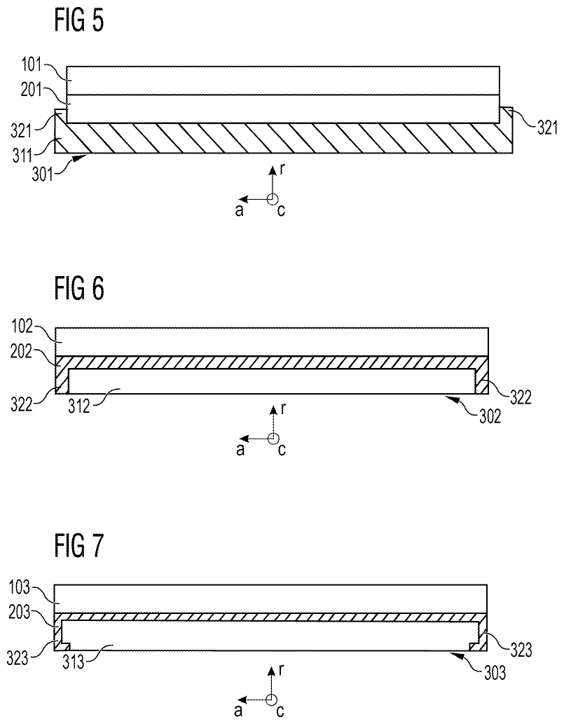

In the embodiment of the partial cross-section according to FIG. 6, a tread 102 carried by a shearband 202 is supported on a supporting structure 302. In particular, a radially outer, annular portion 312 of the supporting structure 302 is partially encompassed by the shearband 202, via radially extending projections 322 (extending in a radially inner direction) of the shearband 202, which are preferably provided at axially outer edges of the shearband 202. Such a configuration mainly helps to avoid relative axial movement between the shearband 202 and the supporting structure 302.

Typically, a shearband will be cured (such as sulfur cured) to a tread portion herein, which provides a reliable connection between those. The radially inner surface of the shearband is preferably buffed, or, in other words, mechanically roughened. Moreover, adhesives are preferably provided at the interface between the shearband and the supporting structure herein.

FIG. 7 shows yet another partial cross-section according to another embodiment of the present invention, in which a circumferential tread portion 103 is radially supported by a shearband 203 which partially encloses a radially outer portion 313 of a supporting structure 303. Again, the shearband 203 comprises radial extensions 323, which carry in the present embodiment additional projections extending in axially inner directions. Such a shape can further improve the connection between the shearband 203 and the supporting structure 303 against relative movement in the radial direction.

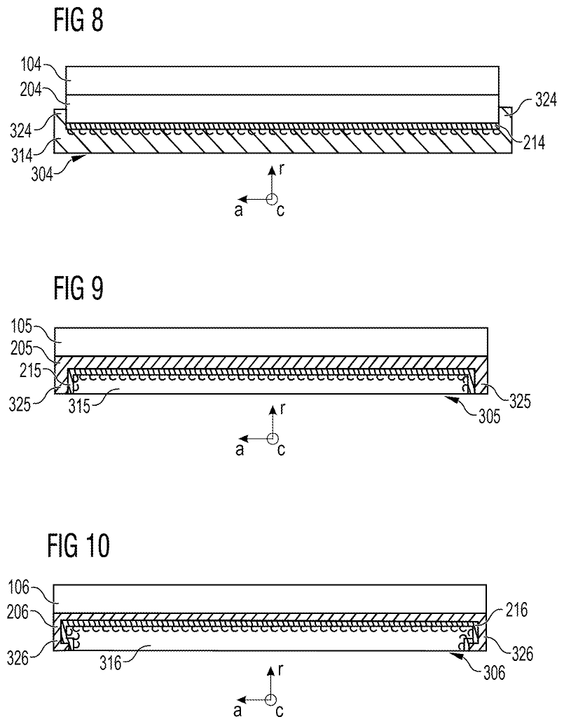

FIG. 8 shows another partial cross-section of a tread 104 carried by a shearband 204 and a radially outer portion 314 of a supporting structure 304. Similar to the embodiment of FIG. 5, the supporting structure 304 comprises radially extending projections 324 which further help to avoid axial relative movement between the shearband 204 and the supporting structure 304. In addition, the embodiment in accordance with FIG. 8 comprises a fabric layer 214 arranged at the interface between the supporting structure 304 and the shearband 204. The fabric layer 214 preferably extends circumferentially in the tire. Moreover, the fabric layer 214 is a textured fabric layer in the present example, having a plurality of hooks or hook shaped fibers extending into the material of the supporting structure 304. As in other embodiments mentioned herein, it is possible that the supporting structure 304 is molded onto the fabric layer 214. The fabric layer 214 is preferably cured to the shearband 204, preferably via an adhesive or dip coating such as known also for the coating of textile fibers used in tire components. One example of such a dip coating material is an RFL based coating.

FIG. 9 shows yet another partial cross-section of a tread 105 supported by a shearband 205. In the present embodiment, the shearband 205 has a similar shape as the shearband 202 of FIG. 6. In addition, the embodiment of FIG. 9 comprises a textured fabric layer 215 bonded to an annular, radially outer portion 315 of the supporting structure 305. For the sake of an improved connection between the shearband 205 and the supporting structure 305, the shearband has radial projections 325.

FIG. 10 shows still another embodiment in a partial cross-section perpendicular to the circumferential direction, in which the shearband 206 has projections 326 extending in a radially inner direction and having end portions pointing in an axially inner direction so as to radially and axially hold the radially outer portion 316 of the supporting structure 306. A tread 106 is co-cured to the shearband 206 and a textured fabric layer 216, which is arranged at the interface between the shearband 206 and the supporting structure 306.

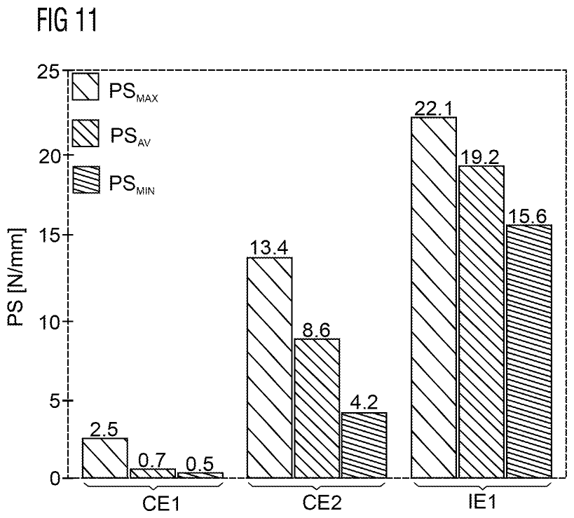

FIG. 11 shows measurement data for three samples CE1, CE2, and IE1 of shearbands connected to a respective supporting structure material. Each sample comprises a buffed shearband surface comprising a rubber composition.

In comparative example CE1, such a buffed and cured shearband surface is chemically bonded to a supporting structure material by a cyano-acrylate adhesive (as Permabond™ 268). The material of the supporting structure of example CE1 is a thermoplastic polyester elastomer (as Hytrel™ 4056 from Dupont). To obtain the measurement data, the shearband and the connected supporting structure material are peeled apart at an angle of 180° (i.e., in opposite directions) at a constant speed of 1 inch per minute and the necessary force to maintain that speed is measured, according to the T-peel test in accordance with ASTM D1876, thereby resulting in the peel strength PS (determined herein in N/mm). In particular, the peel strength PS is the force divided by the specimen width (wherein specimens used herein have 1 inch width and about 6 inch length). FIG. 11 shows for each of the samples CE1, CE2 and IE1 a maximum peel strength PS_{MAX}, a minimum peel strength PS_{MIN} and an average peel strength PS_{AV} which are determined during the peeling process of each sample. For the comparative example CE1, the maximum peel strength is 2.5 N/mm, the average peel strength is 0.7 N/mm and the minimum peel strength is 0.5 N/mm. The average peel strength PS_{AV} is determined over each peeling process per sample.

In comparative example CE2, a shearband as already described for CE1 is bonded with a solvent-based adhesive comprising isocyanates (as Chemlok™ 402X-HS from Parker Hannifin Corporation) to the supporting structure. The material of the supporting structure is again a thermoplastic polyester elastomer (as Hytrel™ 4056 from Dupont). The peel test as such is carried out with the same parameters as for example CE1. For the comparative example CE2, the maximum peel strength is determined as 13.4 N/mm, the average peel strength is 8.6 N/mm and the minimum peel strength is 4.2 N/mm, which are overall better than the corresponding values of CE1.

In accordance with inventive example IE1, an uncured shearband is again bonded to the supporting structure. The material of the supporting structure is again Hytrel™ 4056. In addition, in IE1 a fabric layer is present between the shearband and the supporting structure. Said fabric layer is a polyamide fabric textured with hooks (as a Velcro™ Nylon™ fabric with hooks). The hooks of the utilized fabric have a height of about 2 mm and a diameter of about 0.3 mm. The fabric layer is brushed on both sides with Chemlock™ 402X-HS. Furthermore, the thermoplastic polyester elastomer has been injection-molded onto the surface of the fabric textured with hooks so that the hooks penetrate into the polyester elastomer material (as visible after cutting the sample perpendicularly to the fabric layer). Afterwards the fabric layer carrying the thermoplastic polyester elastomer has been co-cured to the shearband. The maximum peel strength in the inventive example IE1 is determined as 22.1 N/mm, the average peel strength is 19.2 N/mm and the minimum peel strength is 15.6 N/mm. While it can be observed that each value is significantly higher, and thus better than the corresponding values of the comparative examples CE1 and CE2, it is particularly emphasized that the minimum peel strength PS_{MIN} has been improved by almost 4 times compared to comparative example CE2. Thus, the durability of the bond between the shearband and the thermoplastic polymer material of the supporting structure is significantly improved in IE1 over the durability of the comparative examples CE1 and CE2. In particular, the inventors have observed that the thermoplastic polymer material interlocks with the hooks of the fabric which results in a much stronger and reliable bond. Similar tests have successfully been carried out with other textured fabrics, such as with loop textured fabrics, e.g., Nylon fabrics textured with loops. The adhesive coating provided to the fabric layer provides also and increased bonding strength. In particular, the utilized adhesive provides a good bond between the fabric material and rubber composition of the shearband as well as between the fabric layer and the thermoplastic elastomer of the supporting structure.

FIG. 12 shows a preferred embodiment of a method of connecting a shearband to a supporting structure, preferably for making the structure already shown in FIG. 4. As shown in FIG. 12, at the beginning a textured fabric layer 21″ is provided, wherein the fabric layer 21″ has a plurality of hooks 22″ on a first side of the fabric layer 21″. Preferably, the opposite, second side does not carry such hooks 22″.

In an optional step A, the fabric layer 21″ is coated with an adhesive 23″, such as the adhesive of IE 1. In particular, as shown in FIG. 12, both surfaces of the fabric layer may be coated with such an adhesive, optionally with the same adhesive. As another option, the second surface, or the whole fabric layer 21″, may be coated with a different material for an even better bond to rubber compositions, such as with an RFL adhesive. Such coating is preferably carried out before the application of said adhesive and/or preferably before step B. For instance, adhesives can be applied by brushing or dip coating.

In an optional step B, a rubber-based transition layer 50″ is applied onto the second side of the fabric layer 21″. In particular, such a transition layer 50″ can help to further improve the bond of a shearband to the fabric layer 21″, particularly if a shearband is already cured before attaching it to the fabric layer 21″. However, preferably, an uncured shearband is applied.

In step C the fabric layer 21″, optionally carrying the adhesive 23″ is coated with a thermoplastic polymer to form a portion, such as the ring portion 31″, of the supporting structure 30″ on the first surface, which comprises the hooks 22″, of the fabric layer 21″.

In step D, an uncured shearband 20″ (optionally including multiple stacked reinforced layers, not explicitly shown here) and an uncured tread 10″ are applied to the second surface, or in other words radially outer side, of the fabric layer 21″ (either together in a single step or in two consecutive steps), here via the optional uncured transition layer 50″. In another example, it is possible that the shearband 20″ and the tread 10″ are already applied as co-cured components to the fabric layer 21″, which is however less preferred herein.

In step E, the assembled supporting structure 30″, fabric layer 21″, adhesive 23″, optional transition layer 50″, shearband 20″, and tread 10″ are cured, or in other words co-cured, together. For instance, curing may be carried out at temperatures within a range of at least 130° C. to less than 200° C. In particular, the tread, the shearband and the transition layer may comprise sulfur-curable rubber compositions.

FIGS. 13 shows another preferred embodiment of a method of connecting a shearband to a supporting structure.

At first, fabric layer 21″ is provided. The fabric layer 21″ is preferably the same as already shown in FIG. 12.

In step A of FIG. 13, which is the same as in FIG. 12, the surface of the fabric layer 21″ carrying a plurality of hooks 22″ is coated with the adhesive 23″. Furthermore, the opposite surface of the fabric layer 21″ is also coated with the same adhesive 23″. Both adhesives could be different though. It is also possible that only the surface carrying the hooks 22″ is coated with an adhesive. In particular, it is possible that the adhesive covering the side of the fabric layer 21″ which is going to face the supporting structure is chosen for good adhesion between the material of the fabric layer 21″ and the material of the supporting structure, whereas the adhesive covering the side of the fabric layer 21″ which faces a rubber composition surface (such as of a shearband or rubber composition-based transition layer) provides good adhesion between the material of the fabric layer 21″ and the adjacent rubber composition.

In a further (and optional) step F, a transition layer 50″ is applied to the surface of the fabric layer 21″, which is opposite to the surface carrying the hooks 22″. As in the previous embodiment, such a transition layer is a rubber-based, uncured transition layer 50″. Such a transition layer 50″ is of less interest if the adjacent shearband is applied in an uncured state and co-cured later to the fabric layer 21″.

In step G, an uncured shearband 20″ and an uncured tread portion 10″ are attached (either consecutively or already attached to each other) to the transition layer 50″.

In step H, the fabric layer 21″, the uncured transition layer 50″, the uncured shearband 20″, and the uncured tread 10″ are cured together, and thus connected to one another.

According to step I, a radially outer portion 31″ of a supporting structure 30″ is molded (such as injection molded or rotation molded) onto the surface of the fabric layer 21″ which carries the adhesive 23″ and hooks 22″. As an option, steps of molding could include also the molding of supporting elements such as spokes (of the supporting structure), and/or the molding of a hub portion of the tire. During molding the material of the supporting structure is preferably in a liquid state, such as a liquid thermoplastic polymer which solidifies upon cooling. For instance, the liquid thermoplastic polymer is applied (or in other words molded) with a temperature within the range of 150° C. to 300° C.

All features, embodiments, and aspects described herein can be combined with one another.

The present invention provides more durable connections of the interface between a shearband and a thermoplastic supporting structure of a non-pneumatic tire. Mechanical interlocking and/or provision of a fabric layer helps to significantly improve the bond of the shearband to the supporting structure. Additionally, such a bond can be improved by a combination of mechanical interlocking and chemical bonding. Stress concentrations between the supporting structure and the shearband can be reduced.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire comprising:
a circumferential tread portion,
a circumferential shearband carrying the tread portion,
a hub portion, and
a supporting structure supporting the shearband on the hub portion,
wherein the shearband and the supporting structure are mechanically interlocked with each other.

2. The non-pneumatic tire according to claim 1, wherein a radially outer surface of the supporting structure and a radially inner surface of the shearband are mechanically interlocked with each other.

3. The non-pneumatic tire according to claim 1, wherein the tire comprises a fabric layer arranged along a radially outer surface of the supporting structure and a radially inner surface of the shearband.

4. The non-pneumatic tire according to claim 3, wherein the fabric layer comprises one or more of:
a textured fabric,
a fabric comprising one or more of cords and fibers extending out of the surface of the fabric, and
an adhesive coating.

5. The non-pneumatic tire according to claim 4, wherein the fabric comprises one or more of cords and fibers, extending out of the surface of the fabric and having one or more of:
one or more of loop shapes, hook shapes, mushroom hook shapes, rod shapes, angled shapes, zigzag shapes, corrugated shapes, and curved shapes;
a diameter within a range of 0.01 mm and 2 mm; and
a maximum radial extension within a range of 1 mm and 20 mm.

6. The non-pneumatic tire according to claim 1, wherein at least one of a radially outer surface of the supporting structure and a radially inner surface of the shearband comprises protrusions having a radial height within a range of 1 mm to 30 mm.

7. The non-pneumatic tire according to claim 6, wherein said protrusions are one or more of:
elongated protrusions extending essentially in parallel to a circumferential direction of the tire;
elongated protrusions extending transversely to a circumferential direction of the tire; and
elongated protrusions having one or more of a length of at least 5 cm, and a maximum width within a range of 1 mm to 30 mm.

8. The non-pneumatic tire according to claim 6, wherein the supporting structure comprises a thermoplastic polymer engaging with the protrusions of the shearband.

9. The non-pneumatic tire according to claim 1, wherein one of the supporting structures and the shearband at least partially encompasses the other one of the supporting structures and the shearband in a radial direction so as to avoid axial movement of the supporting structure relative to the shearband.

10. The non-pneumatic tire according to claim 1, wherein a connecting layer is provided between the supporting structure and the shearband, and wherein the connecting layer comprises one or more of:
a fabric comprising a plurality of fibers extending out of the surface of the fabric; and
a circumferential, toothed belt.

11. A non-pneumatic tire comprising:
a circumferential tread portion,
a circumferential shearband carrying the tread portion,
a hub portion, and
a supporting structure supporting the shearband on the hub portion,
wherein the tire further comprises a fabric layer extending along a radially inner surface of the shearband and a radially outer surface of the supporting structure.

12. The non-pneumatic tire according to claim 11, wherein the fabric layer comprises a fabric and a plurality of one or more of cords and fibers, extending out of at least one surface of the fabric.

13. The non-pneumatic tire according to claim 11, wherein the fabric layer comprises a material selected from one or more of polyester and polyamide.

14. The non-pneumatic tire according to claim 11, wherein the fabric layer comprises an adhesive coating selected from one or more of isocyanate adhesives, latex based adhesives, solvent based adhesives, reactive adhesives, resorcinol formaldehyde latex adhesives, epoxy adhesives, phenol formaldehyde adhesives, polyurethane adhesives, nylon-phenolic adhesives, nitrile-phenolic adhesives, nitrile based adhesives, neoprene adhesives, modified epoxy adhesives, cyanoacrylate adhesives, modified phenolic adhesives, and resorcinol-formaldehyde adhesives.

15. The non-pneumatic tire according to claim 11,
wherein the supporting structure comprises a thermoplastic polymer; and
wherein the fabric layer comprises a fabric with a plurality of one or more of cords and fibers which extend out of a radially inner surface of the fabric, which are coated with an adhesive, and which extend into the thermoplastic polymer of the supporting structure.

16. The non-pneumatic tire according to claim 15, wherein the inner surface of the shearband comprises a rubber composition and wherein the fabric layer is co-cured to the shearband.

17. The non-pneumatic tire according to claim 15, wherein the thermoplastic polymer is a thermoplastic polyester elastomer and wherein the fabric layer comprises one or more of a polyester and a polyamide.

18. The non-pneumatic tire according to claim 15, wherein the tire further comprises a rubber composition-based transition layer and wherein the fabric layer is connected to the shearband via the rubber composition-based transition layer.

19. The non-pneumatic tire according to claim 15,
wherein the one or more of cords and fibers extending out of the fabric are one or more of hook-shaped and loop-shaped, and are at least partially coated with one or more of a solvent-based adhesive, an adhesive comprising isocyanates, and a solvent-based adhesive comprising isocyanates;
wherein the thermoplastic polymer is a thermoplastic polyester elastomer;
wherein the fabric layer comprises a material chosen from one or more of polyester and polyamide; and
wherein the shearband comprises a rubber composition comprising one or more of natural rubber, synthetic polyisoprene, styrene butadiene rubber and polybutadiene rubber.

20. A method of making a non-pneumatic tire comprising a tread portion, a shearband carrying the tread portion, and a supporting structure supporting the shearband, wherein the method comprises the steps of:
Providing a fabric layer comprising a first surface and a second surface opposite to the first surface, wherein said first surface of the fabric layer comprises a plurality of protrusions;
Applying a thermoplastic polymer onto the first surface to form a portion of the supporting structure comprising the plurality of protrusions protruding into the thermoplastic polymer;
Providing a shearband; and
Curing the shearband to the second surface of the fabric layer.
